(19) United States
(12) Patent Application Publication
(10) Pub. No.: US 2011/0180547 A1
(43) Pub. Date: Jul. 28, 2011

(54) TILTING TOOL CROCK

(75) Inventor: Caroline Park, Venice, CA (US)

(73) Assignee: PROGRESSIVE INTERNATIONAL CORPORATION, Kent, WA (US)

(21) Appl. No.: 13/011,557

(22) Filed: Jan. 21, 2011

Related U.S. Application Data
(60) Provisional application No. 61/297,220, filed on Jan. 21, 2010.

(51) Int. Cl. A47G 23/00; F16M 13/00

(52) U.S. Cl. 220/574; 248/346.5

(57) ABSTRACT

A preferred tilting tool crock includes a main container body supported by a base. The container is pivotally secured to the base such that it can rotate forward in order to view and retrieve an item stored in the crock, then rotate back again. The arrangement of the base and the rotating connection ensures that the container does not fall over despite being tipped forward.

### PRIORITY CLAIM

This application claims the benefit of prior U.S. provisional application Ser. No. 61/297,220 filed Jan. 21, 2010, the contents of which are hereby incorporated by reference.

### FIELD OF THE INVENTION

This invention relates generally to containers for holding kitchen tools such as spoons, whisks, and the like.

### BACKGROUND OF THE INVENTION

A container such as a crock is commonly used to hold a variety of kitchen implements such as spoons, whisks, or other tools. Depending on the number and type of tools in the container, it can be difficult to retrieve a desired tool, and likewise can be difficult to find the tool the user is looking for. It may be easier to see the contents of the container by tipping it, but tipping the container forward may cause it to tip over entirely, spilling the contents or breaking the container. The present invention provides an improved ability to locate and retrieve tools stored in such a container.

### SUMMARY OF THE INVENTION

In accordance with a preferred version of the invention, the tilting tool crock includes a main container body supported by a base. The container is pivotally secured to the base such that it can rotate forward in order to view and retrieve an item stored in the crock, then rotate back again. The arrangement of the base and the rotating connection ensures that the container does not fall over despite being tipped forward.

### BRIEF DESCRIPTION OF THE DRAWINGS

Preferred and alternative examples of the present invention are described in detail below with reference to the following drawings:

FIG. 1 is a perspective view of a preferred tilting tool crock.

FIG. 2 is a side view of a preferred tilting tool crock.

FIG. 3 is a back view of a preferred tilting tool crock.

FIG. 4 is a sectional view of a preferred tilting tool crock, taking along line A-A in FIG. 3.

FIG. 5 is a close-up view of Detail B as indicated in FIG. 4.

FIG. 6 is an exploded view of a preferred tilting tool crock.

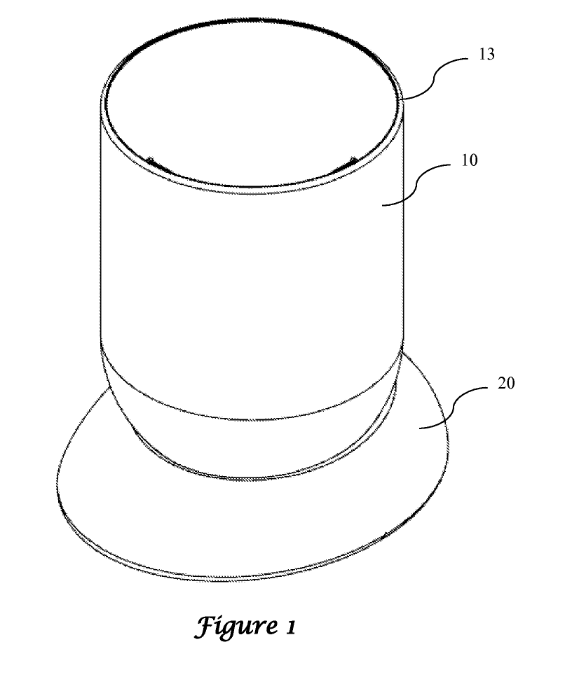

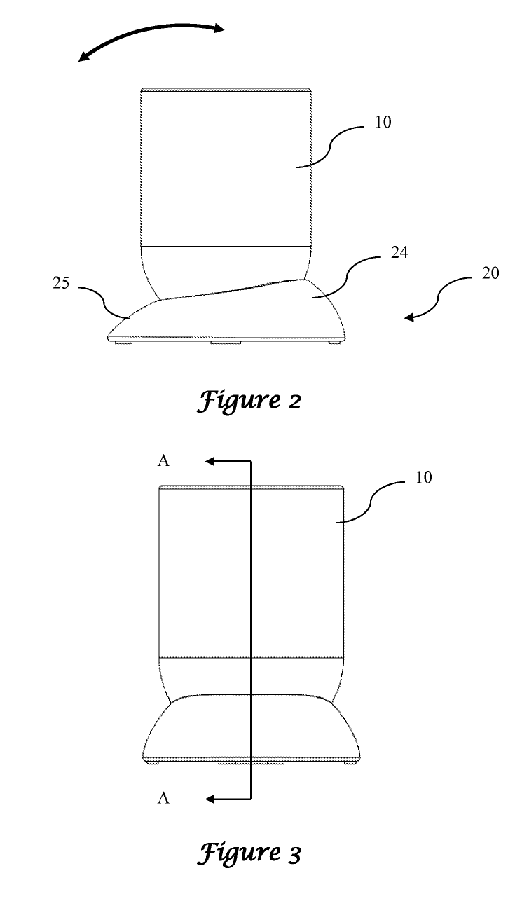

### DETAILED DESCRIPTION OF THE PREFERRED EMBODIMENT

The preferred version of the invention includes a container 10 supported by a base 20. The container is secured to the base in a fashion that allows the container to tilt in a pivoting or sliding fashion within the base, thereby adjusting the orientation of the opening at the rim of the container from a vertical position to one that is angled downward toward the horizontal.

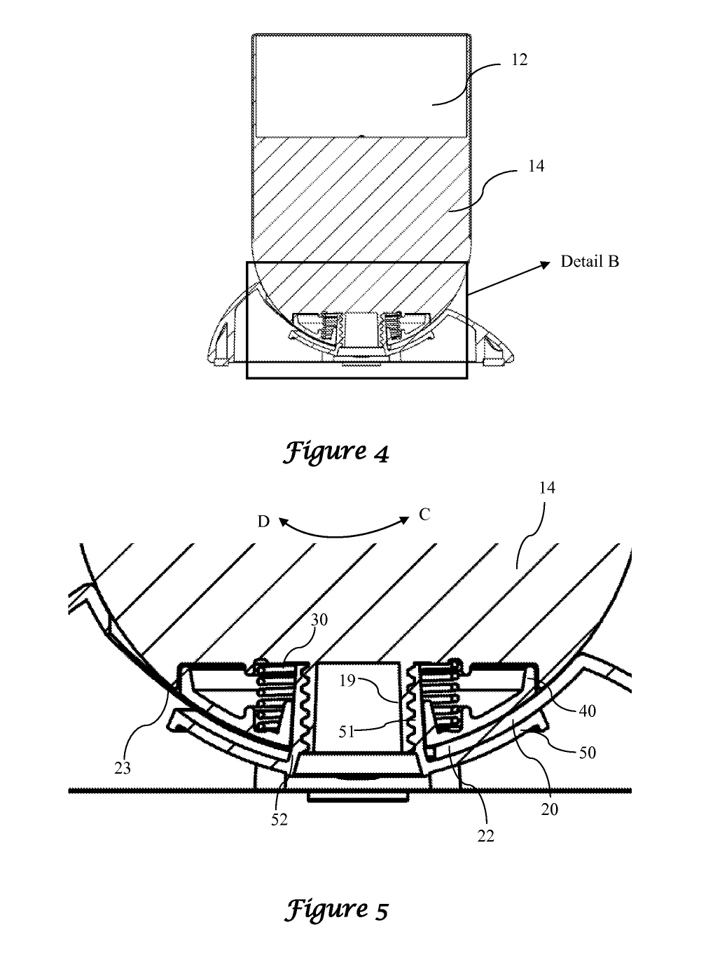

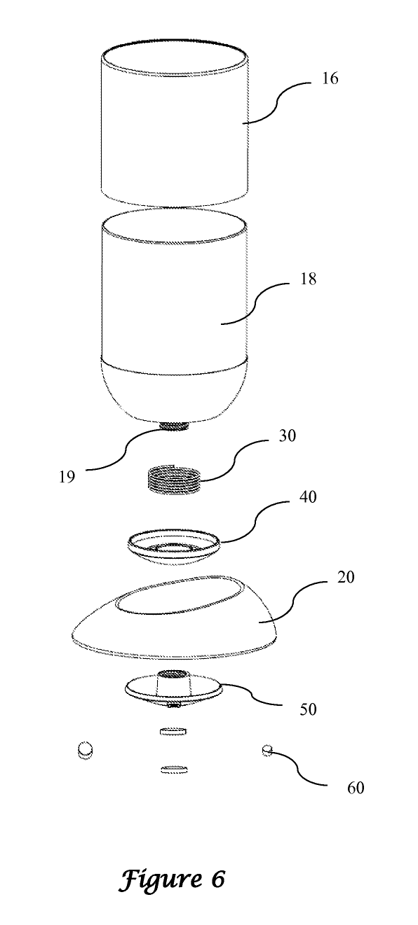

The container generally includes peripheral upwardly extending sidewalls terminating in a rim 13 and forming an interior cavity. As best seen in the sectional view of FIG. 4, the container includes an upper cavity 12 and a lower solid portion 14. As illustrated, the upper cavity occupies about one third or as much as half of the overall height of the container. The lower solid portion provides additional weight and therefore stability against tipping by helping to ensure that the center of gravity of the container is low enough that a moderate tilting of the container will not cause it to tip over entirely, spilling the contents.

In the preferred version, the container includes an inner portion 18 and an external sleeve 16. The sleeve may be formed from stainless steel and provides additional strength and aesthetic attributes. In alternate embodiments, the entire container may be formed from a single material such as plastic.

The container 10 is mounted to the base 20 in a fashion that allows the container to rotate and tilt with respect to the base without tipping. In addition, the connection allows the container to readily return to its original position. Thus, the bottom of the container includes a stem 19 that is threaded in order to mate with threads on the upwardly-extending mount 51 of a lower base plate 50.

An upper base plate 40 is trapped between the rim 22 of the base and the lower base plate on one side and the lower side of the container on the other. In the version as shown, the upper base plate is free-floating between the container and the base, but trapped between them by the connection between the container and the base. A compression spring 30 imparts a force against the base plate 40, pushing it against the base 20. In each case, the upper and lower base plates are formed in a bowl or concave shape, thereby defining an arc of curvature along which the container may slide as it tilts.

A rearward portion 24 of the base has a height that is greater than a forward portion 25 of the base. The base 20 includes a central opening defined by a rim. In general, the central opening is a cutaway portion of the base that defines a path of travel of the stem within the base. In one version, the central opening may be in the form of a slot extending from about the center of the base to a position toward the rear of the base. In other versions, the central opening may be more oval or circular in shape to allow for some lateral travel in addition to a sliding movement in a direction from the front to the rear of the base.

The forward portion 22 of the rim of the central opening extends farther toward the center of the base than the rearward portion 23 of the rim. The forward portion of the rim 22, and the central portion of the base 20 generally, is captured between the upper and lower base plates, and is formed with a concave shape that generally matches that of the upper and lower base plates. As such, the tilting of the container is accomplished by a sliding path defined by the shape of the plates, in which the upper and lower base plates slide away from the forward portion 22 of the rim and back again toward it as it returns to its original position.

The edge of the forward portion 22 of the rim serves as a stop as it engages a shoulder 52 defined at the transition of the base plate where the lower portion of the base plate transitions vertically to the upwardly extending mount 51 in order to limit the sliding movement of the container. As the container slides in a direction in which the rim of the container tips toward the rear of the base (direction C as indicated in the arrow of FIG. 5), the forward portion 22 of the rim abuts the shoulder 52 at the juncture of the stem and mount of the lower base plate, thereby limiting further sliding travel of the container. Accordingly, the container cannot slideably tip backward in a direction that tilts the opening of the container toward the rear of the base. The length and location of the rim may alternatively be formed to allow a greater or lesser desired path of travel, including a portion in which the container cannot tip beyond the vertical in a direction toward the rear of the base.

The rearward portion 23 of the rim is more distant from the center of the base and does not extend fully (or, alternatively, even partially) into the space defined between the upper and lower base plates. Thus, the container can slide along the base in a direction toward the rear of the base (direction D in FIG. 5), thereby tilting the upper opening of the container toward the front of the base. The length of travel in the rearward direction is limited by the size of the opening and the positioning of the rearward portion 23 of the rim with respect to the shoulder 52.

A compression spring 30 is provided between the lower surface of the container and the upper base plate 40. The upper base plate is formed with a concave shape while the lower surface of the container includes a cavity extending upward and into the container. Together with the stem at the bottom of the container, the container cavity is essentially of an annular or donut shape, though not perfectly so and not necessarily with rounded corners. The perimeter of the annular concavity includes shoulders or other abutments which receive a vertical flange formed on the upper base plate to retain the upper base plate substantially in a fixed position with respect to a central axis extending through the container and stem at the bottom of the container.

The compression spring 30 surrounds the stem and includes an upper end that presses against the bottom of the container and a lower end that presses against the upper side of the upper base plate. Thus, the compression spring urges the upper base plate downward and against the rim 22 of the base, thereby increasing the frictional force between the upper base plate and the rim. By selecting the spring size and strength, a desired frictional force can be obtained. In turn, the size of the compression spring determines the ease with which the container may be tilted downward and returned again to its original position. Most preferably, the spring provides a frictional force sufficient to prevent the container from readily tipping under its own weight or that of a kitchen tool resting against the lip of the container. Accordingly, the container will only tip forward when a user grasps the container and pushes or pulls it forward.

In alternate embodiments, different structures may be used to accomplish the frictional force or other resistance to the tilting of the container, either with or without the spring. For example, the length of the stem and base plate mount can be used to create a frictional force between the bottom of the container and the rim of the base.

The base may also include one or more resilient non-skid feet 60 secured to the bottom of the base.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A tilting crock, comprising:
a container having a lower surface, an upper rim, and sidewalls extending between the lower surface and the upper rim, the container defining an interior space; and
a base, the lower surface of the container being slideably secured to the base along an interface between the lower surface of the container and the base to define an arcuate path of travel of the container with respect to the base;
whereby the container is tiltable between a first upright position and a second tilted position.

2. The tilting rock of claim 1, wherein the base further comprises a forward portion and a rearward portion, the forward portion having a height lower than the rearward portion, the base having a central portion between the forward portion and the rearward portion, the central portion being concave in shape.

3. The tilting crock of claim 2, wherein the central portion of the base further comprises a central opening, the central opening being offset from a center of the base and toward the rearward portion of the base.

4. The tilting crock of claim 3, wherein the central opening is further defined by a central opening rim, the central opening rim having a forward rim portion and a rearward rim portion.

5. The tilting crock of claim 4, wherein the lower surface of the container is concave in shape and substantially matched to the shape of the central portion of the base.

6. The tilting crock of claim 5, wherein the lower surface of the container further comprises a stem, the stem extending through the central opening, whereby sliding movement of the container with respect to the base is defined by a path of travel of the stem within the central opening.

7. The tilting crock of claim 6, further comprising a lower base plate and an upper base plate, the lower base plate being secured to the stem, at least a portion of the central opening rim being trapped between the upper base plate and lower base plate.

8. The tilting crock of claim 7, further comprising a spring having a first end abutting the lower surface of the container and a second end abutting the upper base plate, whereby the spring urges the upper base plate against the central opening rim.

9. A tilting crock, comprising:
a base having a concave upper surface and a central opening having a central opening rim; and
a container having a convex external lower surface for slideably receiving the concave upper surface of the base, the container defining an interior space; the container further having a cavity formed centrally along the convex external lower surface, the cavity having a downwardly extending stem; and
a lower base plate secured to the stem, the lower base plate further having a flange abutting a lower surface of the base; and
an upper base plate, at least a portion of the central opening rim being trapped between the upper base plate and the lower base plate;
whereby the container is tiltable between a first upright position and a second tilted position.

10. The tilting crock of claim 9, further comprising a spring positioned within the cavity and surrounding the stem, the spring having a first end abutting the container and a second end abutting the upper base plate to urge the upper base plate against the base.

11. The tilting crock of claim 10, wherein the stem is threadably mounted to the lower base plate.

12. The tilting crock of claim 10, wherein the container further comprises an upper portion and a lower portion, the lower portion being weighted.

13. The tilting rock of claim 10, wherein the base further comprises a forward portion and a rearward portion, the forward portion having a height lower than the rearward portion.

14. The tilting crock of claim 11, wherein the central opening is offset from a center of the base and toward the rearward portion of the base.

15. A tilting crock, comprising:
a base having a concave upper surface and a central opening having a central opening rim; and
a container having a convex external lower surface for slideably receiving the concave upper surface of the base, the container defining an interior space; the container further having a cavity formed centrally along the convex external lower surface; and
a lower base plate secured to the container within the cavity, the lower base plate further having a flange abutting a lower surface of the base; and
an upper base plate, at least a portion of the central opening rim being trapped between the upper base plate and the lower base plate;
whereby the container is tiltable between a first upright position and a second tilted position.

16. The tilting crock of claim 15, wherein the container is threadably mounted to the lower base plate.

17. The tilting crock of claim 15, wherein the container comprises an upper portion and a lower portion, the lower portion comprising substantially one third of an overall height of the container, the lower portion being solid and the interior space being formed entirely within the upper portion.
